(19) United States
(12) Patent Application Publication
(10) Pub. No.: US 2001/0031181 A1
(43) Pub. Date: Oct. 18, 2001

(54) Indexable drill and cutting inserts therefor

(76) Inventors: Fred T. Shallenberger, Rockford, IL (US); James Joiner, Rockford, IL (US)

Correspondence Address: Larry R. Meenan, Kennametal Inc., P.O. Box 231, Latrobe, PA, 15650, US

(21) Appl. No.: 09/735,242

(22) Filed: Dec. 12, 2000

Related U.S. Application Data
(60) Provisional application No. 60/171,371, filed on Dec. 22, 1999.

(51) Int. Cl. B23B 51/02

(52) U.S. Cl. 408/230; 408/227

(57) ABSTRACT

The invention relates to an indexable drill for drilling a hole in a metal workpiece. The drill includes an elongated generally cylindrical body having a central longitudinal axis and a pair of cutting inserts. The body includes a tip end portion having first and second recessed pockets on generally diametrically opposite sides of the longitudinal axis. Each cutting insert is removably secured within a pocket and includes at least one cutting edge having an outer peripheral corner and an inner corner. The at least one cutting edge extends linearly from the outer peripheral corner to a curve extending convexly toward an inner region proximate the central longitudinal axis and then to a linear relief edge extending linearly from the inner region in a direction away from the longitudinal axis to the inner corner.

### FIELD OF THE INVENTION

This invention relates generally to an indexable drill and cutting inserts therefor. More particularly, the present invention relates to an indexable drill including cutting inserts having improved relief surfaces for forming holes in a metal workpiece.

### BACKGROUND OF THE INVENTION

The prior art method of drilling holes has been by the use of twist drills, twist drills with brazed carbide tips or drills having indexable carbide inserts. The use of drills having indexable carbide inserts is often preferred because of their consistent quality and overall cost effectiveness. Typically, the inserts of an indexable drill are located one on each side of the axis of the drill and are positioned to cut the entire circumference of the hole during each one-half revolution of the drill. As the drill cuts the metal workpiece, a small diameter core is left between the two inserts at the center of the hole that is eventually twisted off as the depth of penetration of the drill increases. For a more detailed discussion of the operation of an indexable drill, reference is made to U.S. Pat. Nos. 5,092,718 and 4,373,839, incorporated herein by reference.

Although indexable drills for drilling holes in a metal workpiece have enjoyed commercial success, further improvements in the design of indexable drills is desired. It is an object of the present invention to provide an indexable drill. Another object of the present invention is to provide an indexable drill having uniquely shaped cutting inserts for improved performance. Yet, another object of the present invention is to provide a drill having triangular inserts with uniquely shaped cutting edges. Another object of the present invention is to provide a uniquely shaped triangular insert having an improved relief edge.

### SUMMARY OF THE INVENTION

Briefly, according to the present invention, there is provided an indexable drill for drilling a hole in a metal workpiece. The drill includes an elongated generally cylindrical body having a central longitudinal axis and a pair of cutting inserts. The body includes a tip end portion having first and second recessed pockets on generally diametrically opposite sides of the longitudinal axis. Each cutting insert is removably secured within a pocket and includes at least one cutting edge having an outer peripheral corner and an inner corner. At least one cutting edge extends linearly from the outer peripheral corner to a curve extending convexly toward an inner region proximate the central longitudinal axis and then to a linear relief edge extending linearly from the inner region in a direction away from the longitudinal axis to the inner corner.

### BRIEF DESCRIPTION OF THE DRAWINGS

Further features and other objects and advantages of this invention will become clear from the following detailed description made with reference to the drawings in which:

FIG. 1 is a perspective view of an indexable drill including two cutting inserts;

FIG. 2 is an enlarged top view of the tip end portion of the drill illustrated in FIG. 1;

FIG. 3 is a perspective view of a cutting insert;

FIG. 4 is a top view of the cutting insert of FIG. 3;

FIG. 5 is a side view of the cutting insert of FIG. 3;

FIG. 6 is a bottom view of the cutting insert of FIG. 3; and

FIGS. 7-9 are enlarged partial top views of alternate embodiments of cutting inserts, in accordance with the present invention as positioned in the indexable drill of FIG. 1.

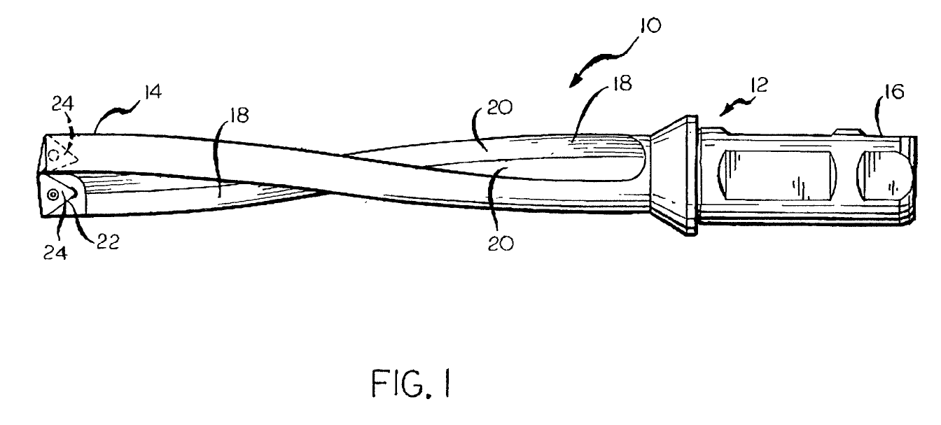

### DETAILED DESCRIPTION OF THE INVENTION

Referring to the figures, wherein like reference characters represent like elements, there is shown an indexable drill 10 for forming a cylindrical hole in a metal workpiece. The metal workpiece may be made of iron, steel, nickel alloys, aluminum alloys, as well as other materials. The indexable drill 10 comprises an elongated and generally cylindrical body 12 having a tip end portion 14 and an opposite shank end portion 16. The indexable drill 10 may be made of high carbon steel, tool steel, and the like. The indexable drill 10 is sized to fit within a rotary powered chuck, as well known in the art for effecting rotation of the drill about its central axis. It will be appreciated that the indexable drill 10 may also be held rotationally stationary and that the metal workpiece may be rotated about the axis of the drill and perform equally as well.

Two generally diametrically spaced flutes 18 are formed in the body 12 of the indexable drill 10. The flutes 18 extend helically around and along substantially the entire length of the body 12 from the tip end 14 toward the shank end 16 to enable metal chips to escape from the hole that is being cut in the metal workpiece. Each flute 18 may be formed by a pair of sidewalls 20 to define a general V-shape in radial cross-section, as well known in the art.

Formed in the tip end portion 14 of the body 12 and in communication with the flutes 18 are diametrically spaced recessed pockets 22 for seating the cutting inserts 24. The pockets 22 for the cutting inserts 24 each include a flat back support 26 against which the cutting inserts are seated and two side walls 28 angled relative to one another so as to cause the pockets to be formed with a generally V-shaped configuration. When each cutting insert 24 is located in its respective pocket 22, the edge surfaces 30 of the insert seat against the side walls 28 of the pocket.

The back support 26 of each pocket 22 may be inclined relative to the central longitudinal axis C so as to cause a cutting edge 32 of each cutting insert 24 to be disposed at a negative axial rake angle, meaning that the leading face of the insert is located ahead of the cutting edge. As a result, the edge surface 30 of each cutting insert 24 is tipped in such a direction as to define a clearance face 34 and to avoid rubbing against the bottom of the hole during drilling thereof. In a preferred embodiment, the negative axial rake angle is approximately 4 degrees.

As shown in the Figures, the cutting insert 24 is preferably in the shape of an equilateral triangle having three edge surfaces 30 of substantially equal length and joining one another at three corners 38. The three edge surfaces 30 extend between two oppositely facing and generally planar surfaces; a forward clearance face 34 and a rearward face 40. The cutting edge 32 is defined by the intersection of the forward clearance face 34 and an edge surface 30. The forward clearance face 34 surface of the cutting insert 24 may include a chip-breaking groove that is located just inwardly of the periphery of the face surface.

The cutting insert 24 is preferably positioned such that the insert cutting edge 32 is located at a negative radial rake. In other words, the cutting edge 32 is positioned ahead of the central radial line B that parallels the cutting edge and thus the corner of the cutting insert behind the cutting edge clears the peripheral wall of the hole so as to avoid rubbing against the wall. In a preferred embodiment, the cutting edge 32 is positioned approximately 0.140″ ahead of the aforementioned radial line B.

The cutting edge 32 of the cutting insert 24 may also be inclined at a lead angle of about 8 degrees. As a result of the lead angle, the cutting edge 32 slopes toward the shank end 16 of the body 12 as the edge progresses outwardly toward the peripheral wall of the hole. This causes the center portion of the hole to be cut somewhat before cutting of the peripheral portion and facilitates initial penetration of the drill 10 into the metal workpiece.

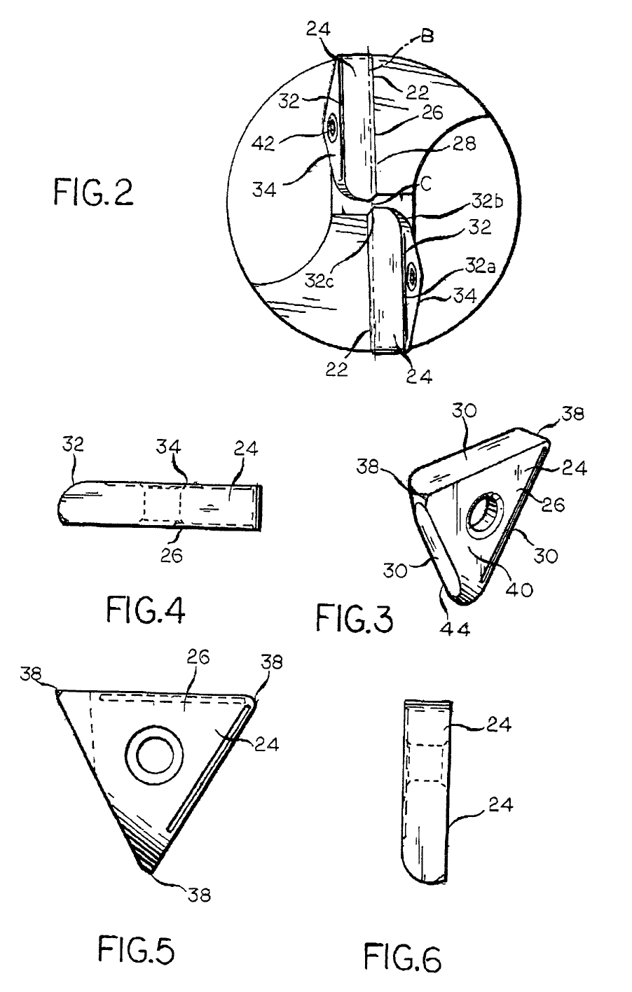

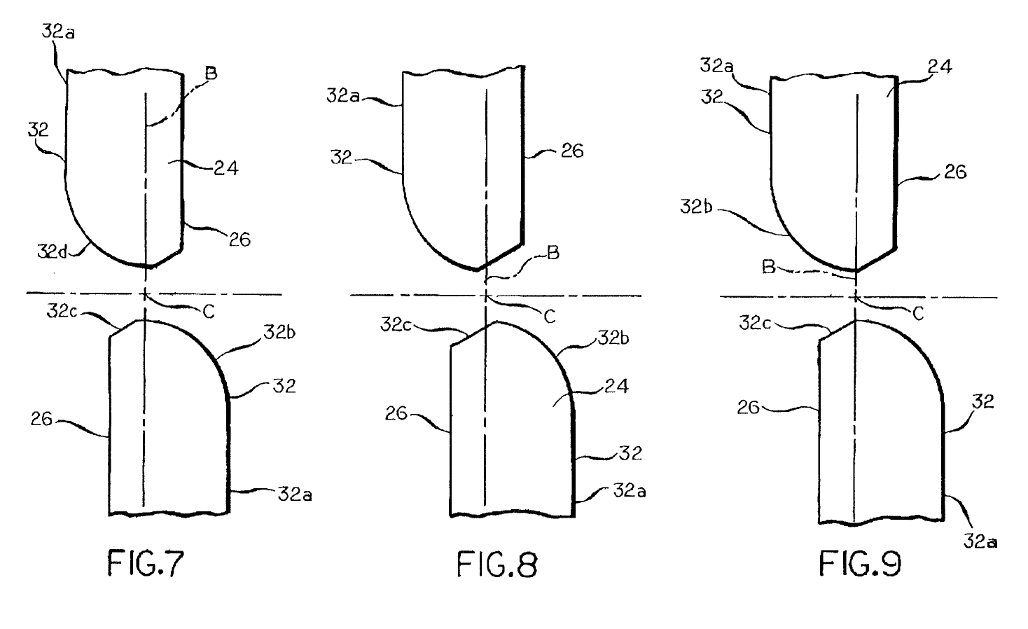

Referring to FIG. 2, the cutting inserts 24 are shown properly seated within their respective pockets 22. The corners of the cutting inserts 24 are spaced from one another to avoid interference between the inserts and the forward clearance face 34 of the cutting inserts are positioned in the direction of rotation to present the cutting edges 32. The cutting edges 32 extend linearly from the outer peripheral corner to the inner corner along most of the radial length as indicated at 32a. Upon approaching the inner corner, the cutting edges curve convexly out of the plane of the forward clearance face of each insert 32b and toward the central axis C and then transitions linearly away from the central axis 32c. As shown in FIGS. 7-9, the curved portion of the cutting edge 32b terminates at an inner region located on or approximate the central radial line B extending through the central axis C and parallel to the linear portion of the cutting edge from the outer peripheral corner 32a. As shown in FIGS. 7-9, the linear portion 32c functions as a linear relief edge to provide clearance during cutting. The linear relief edge 32c may begin ahead of the location of the central axis (FIG. 8), at the location of the central axis (FIG. 9) or behind the central axis (FIG. 7). In a preferred embodiment, for increased clearance, the linear relief edge 32c begins ahead of the location of the central axis C. The angle of the linear relief edge with respect to the radial line B may vary from about 10° to 60°.

With the foregoing arrangement, rotation of the indexable drill 10 causes the cutting edge 32 of each insert 24 to cut across almost a full radius of the hole. Each cutting edge 32 sweeps around one-half the circumference of the hole during each one-half revolution of the drill 10 and thus the two cutting edges cooperatively cut the full circumference of the hole every one-half revolution. This enables rapid axial feeding of the drill 10. No cutting is performed beyond the inner region.

A hole is formed through each cutting insert 24 and extends between and perpendicular to the forward clearance face 34 surfaces of the cutting insert. To secure the cutting inserts 24 in the pockets 22, a fastener 42 such as a threaded screw or locking pin of a type well known in the art extends through each hole and is threaded into a tapped hole in the body 12. When the fastener 42 is tightened, the fastener 42 clamps the cutting insert 24 against the pocket 22.

Each cutting insert 24 preferably is formed with an alternately usable cutting edge 44 that is formed along the junction of the forward clearance face 34 with the edge surface 30. Other than for location, the cutting edge 44 is identical to the cutting edge 32 and includes linear 32a and 32c and curved portions 32b similar to the linear and curved portions of the cutting edge 32. Accordingly, after a cutting edge 32 or 44 of each cutting insert 24 has become worn, the cutting insert 24 may be removed from the pocket 22 and indexed to present a new cutting edge 32 or 44. By both inverting and indexing the cutting insert 24, the cutting edge 32 and 44 may be brought into active cutting position.

The cutting inserts 24 may be formed of tungsten carbide or other suitable cutting material, as well known in the art. Although the cutting inserts 24 are shown having a triangular shape, it will be appreciated that the inserts may be of most any suitable shape and size that is sufficiently strong to withstand the heavy cutting forces imposed on the inserts and to fit within the pockets. For example, the cutting inserts may be polygonal, square, diamond and the like.

The invention will be further clarified by a consideration of the following examples, which are intended to be purely exemplary of the invention.

### EXAMPLE

A H-100 Special from Rogers Tool Works insert, Style 996035 MOD. A, Code 59960353847TES, Grade 3847, was tested on a Okuma LB25 CNC lathe to machine 4140 alloy steel @ 30 Rc. The tool was aligned with the spindle and checked before running the test. Radial and axial run out were within 0.001 inch

1st Test

277-3100 Powrdrill powerdrill from Rogers Tool Works, Inc. (Powrdrill is a trademark of Rogers Tool Works, Inc.) with a 3:1 diameter/length ratio. Tool measured at 0.996 diameter over inserts.

Speed—400 SFM, 1528 RPM

Feed rate—0.006 IPR (0.003 chip load per blade, 9.17 IPM)

20 holes drilled to 2.5 inch depth. The inserts were visually inspected and found to be chipped at backside of the center radius due to lack of chip clearance. Up to that point, all holes were at 0.996 inch diameter with good finish, good chip control and good chip evacuation. Machine spindle horsepower and thrust consumption were within acceptable limits.

2nd Test

277-7100 Powrdrill powerdrill from Rogers Tool Works, Inc. (Powrdrill is a trademark of Rogers Tool Works, Inc.) with a 7:1 diameter/length ratio. Tool measured at 0.997 over inserts.

Speed—400 SFM, 1528 RPM

Feed Rate—0.002 IPR (3.06 IPM) for 0.200 depth, then increased to 0.006 IPR (9.17 IPM)

The drill drilled 7 holes through 6-inch long steel slugs made of the same material as above. Holes were on size with good finish. Chip control and chip evacuation were good. Again, the inserts chipped at the center after 7 holes. It appeared that there is not enough clearance on the back side of the insert cutting edge radius.

In both tests, the thrust meter showed marginally less at the start of the cut, but as the tool progressed deeper into the cut, the increase of thrust consumption was lessened.

The foregoing tests 1 and 2 were repeated using an insert design as shown in FIG. 7 of the same grade as above.

1st Test

The machine used was an Okuma LB25 CNC lather. The tool alignment with the spindle was checked before running the test. Radial and axial runout were within 0.001 inch The material machined was 4140 alloy steel at 30 Rc.

The 1st test was using a 277-3100 Powrdrill powerdrill from Rogers Tool Works, Inc. (Powrdrill is a trademark of Rogers Tool Works, Inc.) with a 3:1 diameter/length ratio. The tool measured at 0.996 inch diameter over inserts.

Speed—400 SFM, 1528 RPM

Feed Rate—0.006 IPR (0.003 chip load per blade, 9.17 IPM)

30 holes were drilled to 2.5 inch depth. The inserts did not fail. Hole size, finish, chip formation and chip evacuation were at acceptable levels. Machine spindle horsepower and thrust consumption were acceptable. There was no insert chipping at the center as previously observed.

2nd Test

277-7100 Powrdrill powerdrill from Rogers Tool Works, Inc. (Powrdrill is a trademark of Rogers Tool Works, Inc.) with a 7:1 diameter/length ratio. Tool measured at 0.997 over inserts.

Speed—400 SFM, 1528 RPM

Feed Rate—0.002 IPR (3.06 IPM) for 0.200 depth, then increased to 0.006 IPR (9.17 IPM)

The drill drilled 7 holes through 6-inch long steel slugs made of the same material as above. Holes were on size with good finish. Chip control and chip evacuation were good. Although there was no insert chipping as previously observed the inserts showed wear at the center of the cutting edge, possibly due to edge build-up.

In both tests, the thrust meter showed marginally less at the start of the cut, but as the tool progressed deeper into the cut, the increase of thrust consumption was lessened. The performance of the insert was a definite improvement over previous designs. There was no sign of failure at the linear relieved section behind the cutting radii, even with the increased gap between the inserts from the new design in accordance with the present invention.

The patents and documents described herein are hereby incorporated by reference.

Having described presently preferred embodiments of the invention, the invention may be otherwise embodied within the scope of the appended claims.

What is claimed is:

1. A drill for drilling a hole in a metal workpiece comprising:
an elongated generally cylindrical body having a central longitudinal axis, the body including a tip end portion having first and second recessed pockets on generally diametrically opposite sides of the longitudinal axis; and
a pair of cutting inserts, each cutting insert removably secured within a pocket;
wherein each insert includes at least one cutting edge having an outer peripheral corner and an inner corner, the at least one cutting edge extending linearly from the outer peripheral corner to a curve extending convexly toward an inner region proximate the central longitudinal axis and then to a linear relief edge extending linearly from the inner region in a direction away from the longitudinal axis to the inner corner.
